(19) United States
(12) Patent Application Publication
(10) Pub. No.: US 2025/0094877 A1
(43) Pub. Date: Mar. 20, 2025

(54) LARGE MODEL-BASED METHOD OF GENERATING TEXT AND METHOD OF TRAINING TEXT GENERATION MODEL

(71) Applicant: Beijing Baidu Netcom Science Technology Co., Ltd., Beijing (CN)

(72) Inventors: Fan WANG, Beijing (CN); Hua WU, Beijing (CN); Yingzhan LIN, Beijing (CN); Zengfeng ZENG, Beijing (CN); Yufeng HU, Beijing (CN); Jianhui DING, Beijing (CN); Haifeng WANG, Beijing (CN)

(21) Appl. No.: 18/969,719

(22) Filed: Dec. 5, 2024

(30) Foreign Application Priority Data
Jul. 31, 2024 (CN) 202411045495.X

(51) Int. Cl. G06N 20/00

(52) U.S. Cl. CPC G06N 20/00

(57) ABSTRACT

A large model-based method of generating a text, a method of training a text generation model, a device, and a medium are provided, which relate to a field of artificial intelligence technology, specifically to fields of deep learning, natural language processing and large model technologies. The large model-based method of generating a text includes: acquiring a memory state for a text to be processed, where the memory state is generated based on a previous text of the text to be processed; determining an embedding feature of the text to be processed as an initial hidden state, and processing the memory state and the initial hidden state by using a first attention mechanism to obtain an updated hidden state; and generating a subsequent text for the text to be processed based on the updated hidden state.

This application claims the benefit of priority to Chinese Patent Application No. 202411045495X, filed on Jul. 31, 2024. The entire contents of this application are hereby incorporated herein by reference.

### TECHNICAL FIELD

The present disclosure relates to a field of artificial intelligence technology, and in particular to fields of deep learning, natural language processing and large model technologies, and more specifically to a large model-based method of generating a text, a method of training a text generation model, a device, and a medium.

### BACKGROUND

With a development of computer technology and network technology, applications of deep learning models are becoming increasingly extensive, and deep learning models have made breakthroughs in various fields.

In a field of natural language processing, it is possible to capture a long-distance semantic feature in a text by using a recurrent model or a Transformer model. However, with an increase of a text length of inference, an inference effect may decrease significantly, and the inference may have a high complexity.

### SUMMARY

The present disclosure provides a large model-based method of generating a text, a method of training a text generation model, a device, and a medium.

According to an aspect of the present disclosure, a large model-based method of generating a text is provided, including: acquiring a memory state for a text to be processed, where the memory state is generated based on a previous text of the text to be processed; determining an embedding feature of the text to be processed as an initial hidden state, and processing the memory state and the initial hidden state by using a first attention mechanism to obtain an updated hidden state; and generating a subsequent text for the text to be processed based on the updated hidden state.

According to another aspect of the present disclosure, a method of training a text generation model is provided, including: acquiring a sample text, where the sample text includes a plurality of text segments obtained by dividing a long text; for each text segment of the plurality of text segments: acquiring a memory state for the text segment, where the memory state is generated based on a previous text of the text segment; determining an embedding feature of the text segment as an initial hidden state, and processing the memory state and the initial hidden state by using an encoding network in the text generation model to obtain an updated hidden state; and generating, based on the updated hidden state, a subsequent text for the text segment by using an output layer in the text generation model; and training the text generation model based on the sample text and subsequent texts for the plurality of text segments, where the encoding network is configured to process the memory state and the initial hidden state by using a first attention mechanism.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the large model-based method of generating the text or the method of training the text generation model provided in the present disclosure.

According to another aspect of the present disclosure, a non-transitory computer-readable storage medium having computer instructions therein is provided, and the computer instructions are configured to cause a computer to implement the large model-based method of generating the text or the method of training the text generation model provided in the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a schematic diagram of an application scenario of a large model-based method and apparatus of generating a text and a method and apparatus of training a text generation model according to embodiments of the present disclosure;

FIG. 2 shows a schematic flowchart of a large model-based method of generating a text according to embodiments of the present disclosure;

FIG. 3 shows a schematic diagram of a principle of obtaining an updated hidden state according to embodiments of the present disclosure;

FIG. 4 shows a schematic diagram of an implementation principle of a large model-based method of generating a text according to embodiments of the present disclosure;

FIG. 5 shows a schematic flowchart of a method of training a text generation model according to embodiments of the present disclosure;

FIG. 6 shows a schematic diagram of a principle of back-propagating a gradient of an objective function according to embodiments of the present disclosure;

FIG. 7 shows a structural block diagram of a large model-based apparatus of generating a text according to embodiments of the present disclosure;

FIG. 8 shows a structural block diagram of an apparatus of training a text generation model according to embodiments of the present disclosure; and

FIG. 9 shows a block diagram of an electronic device used to implement a large model-based method of generating a text or a method of training a text generation model according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In a field of natural language processing, it is possible to capture a long-distance semantic feature in a text by using a recurrent model or a Transformer model. For example, it is possible to generate a text using Transformer. However, due to a limitation of an encoding length of an attention mechanism, it is generally only possible to encode a short text, that is, it is difficult to memorize semantics of a long text and accurately infer a long text. For example, it is possible to generate a text using a long short-term memory network. However, it is needed to perform a series of complex gating operations for each token, which results in a high computational complexity and a low inference efficiency.

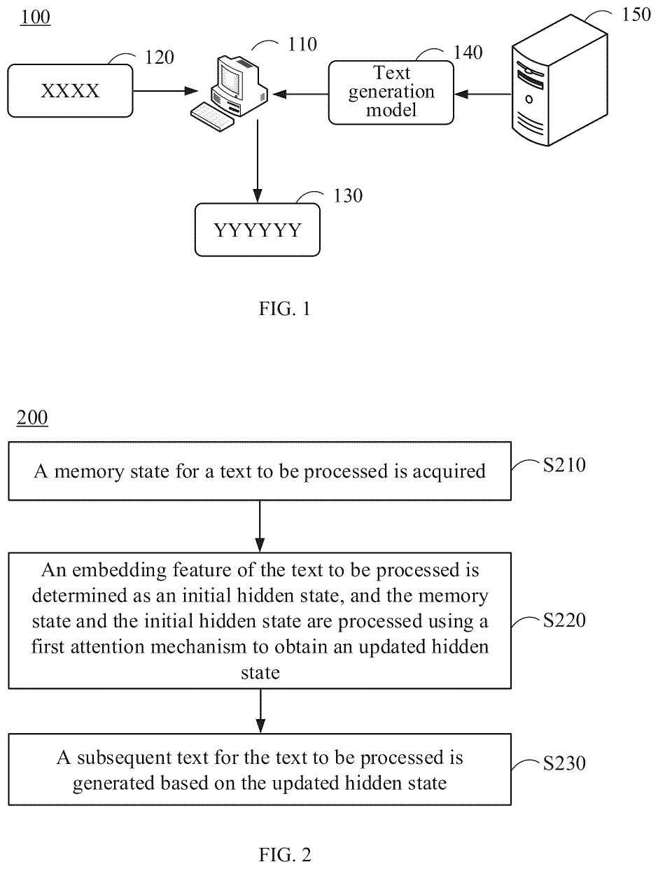

In order to solve problems existing in related art, the present disclosure provides a large model-based method and apparatus of generating a text, a method and apparatus of training a text generation model, a device, a medium, and a program product, which ensure an inference effect and reduce an inference complexity. An application scenario of the methods and apparatuses provided in the present disclosure will be described below with reference to FIG. 1.

FIG. 1 shows a schematic diagram of an application scenario of a large model-based method and apparatus of generating a text and a method and apparatus of training a text generation model according to embodiments of the present disclosure.

As shown in FIG. 1, an application scenario 100 of such embodiments may contain an electronic device 110, which may be any electronic device having processing functions, including but not limited to a smart phone, a tablet computer, a laptop computer, a desktop computer, a server, and so on.

The electronic device 110 may have a text processing function for processing an input text 120 to predict a subsequent text 130 of the text 120. In an embodiment, the electronic device 110 may further have, for example, an intelligent speech function for converting a speech signal provided by a user into a text 120, generating a subsequent text 130 of the text 120, and converting the subsequent text 130 into a speech signal for playback, so as to achieve an intelligent interaction with the user.

For example, the electronic device 110 may encode the text 120 by using a model that combines an attention mechanism and a recursive mechanism. In this way, an encoding length of an attention network may not be limited to locality, and a long-term information may be accumulated by recurrence, thereby affecting and correcting a subsequent inference process. That is, in a scenario of text generation, the text generation model may include a large model that combines the attention mechanism and the recursive mechanism.

For example, the electronic device 110 may process the text 120 by using the text generation method provided in the present disclosure to generate the subsequent text 130. In this way, it is possible to transfer semantics of a long text and generate an infinitely long text. Accordingly, the electronic device 110 may implement the text generation method using a text generation model 140 provided in the present disclosure.

As shown in FIG. 1, the application scenario 100 may further include a server 150, which may be a background management server that supports an operation of a client application in the electronic device 110. The electronic device 110 may be communicatively connected to the server 150 through a network, and the network may include a wired or wireless communication link. The server 150 may also be a cloud server, a server of a distributed system, or a server combined with a block-chain.

For example, the server 150 may train the text generation model 140 using a large amount of long texts, and send the trained text generation model 140 to the electronic device 110 in response to an acquisition request from the electronic device 110, so that the electronic device 110 may generate the subsequent text 130 using the text generation model 140.

In an embodiment, the electronic device 110 may further send the text 120 to the server 150, and the server 150 may process the text 120 using the trained text generation model to obtain the subsequent text 130.

It should be noted that the large model-based method of generating the text provided in the present disclosure may be performed by the electronic device 110 or the server 150. Accordingly, the large model-based apparatus of generating the text provided in the present disclosure may be arranged in the electronic device 110 or the server 150. The method of training the text generation model provided in the present disclosure may be performed by the server 150. Accordingly, the apparatus of training the text generation model provided in the present disclosure may be arranged in the server 150.

It should be understood that the number and type of electronic device 110 and server 150 shown in FIG. 1 are merely schematic. According to implementation needs, any number and type of electronic device 110 and server 150 may be provided.

The large model-based method of generating the text provided in the present disclosure will be described in detail below with reference to FIG. 2 to FIG. 4.

FIG. 2 shows a schematic flowchart of a large model-based method of generating a text according to embodiments of the present disclosure.

As shown in FIG. 2, a large model-based method 200 of generating a text in such embodiments may include operation S210 to operation S230.

In operation S210, a memory state for a text to be processed is acquired.

According to embodiments of the present disclosure, the text to be processed may be a text input by a user or a text obtained by converting a speech provided by the user, which is not limited in the present disclosure.

The memory state for the text to be processed may be a memory state obtained by processing other texts before processing the text to be processed using the large model-based method of generating the text, or may be a randomly generated memory state. In such embodiments, the memory state may be understood as memory cells involved in LSTM. The memory state may express, for example, a semantic information of a previous text of the text to be processed. For example, the memory state may be generated based on the previous text of the text to be processed. In a case of no previous text of the text to be processed, it is possible to acquire a randomly generated memory state.

In an embodiment, it is also possible to extract a semantic information from the previous text of the text to be processed according to any text semantic extraction principle, and determine the extracted semantic information as the memory state.

In operation S220, an embedding feature of the text to be processed is determined as an initial hidden state, and the memory state and the initial hidden state are processed using a first attention mechanism to obtain an updated hidden state.

According to embodiments of the present disclosure, the first attention mechanism may be a cross attention mechanism or a unidirectional attention mechanism.

For example, in operation S220, it is possible to calculate using a cross attention mechanism with the initial hidden state as a query feature and the memory state as a key feature and a value feature, and a calculated result may be used as the updated hidden state.

For example, in operation S220, it is possible to calculate using a cross attention mechanism with the initial hidden state as a query feature and with a concatenated feature obtained by concatenating the initial hidden state and the memory state as a key feature and a value feature, and a calculated result may be used as the updated hidden state.

In operation S230, a subsequent text for the text to be processed is generated based on the updated hidden state.

In such embodiments, after the updated hidden state is obtained, the updated hidden state may be processed using a fully connected network or a normalized network to obtain the subsequent text.

For example, the updated hidden state may be represented by H. In such embodiments, the updated hidden state may be processed using softmax function in Equation (1) below, so as to generate a subsequent text Yₜ, where W and b are network parameters.

$${Y}_{t} = Softmax ( W \cdot {H}_{t} + b ) \qquad Equation ( 1 )$$

According to embodiments of the present disclosure, as the memory state generated based on the previous text of the text to be processed is taken into account in the text generation, the semantic information of the previous text of the text to be processed may be combined in the text generation, which is conductive to a high-precision generation of a long text. For example, due to the use of attention mechanism in the text generation and consideration of the memory state generated based on the previous text, it is possible to reduce an inference cost compared to a technical solution of generating a text using LSTM, and it is possible to capture a longer semantic information compared to a technical solution of generating a text only based on attention mechanism. Overall, the large model-based method of generating the text in embodiments of the present disclosure combines recursive thinking and attention mechanism, thus enabling inference of text with an arbitrary length without reducing accuracy and generation efficiency.

In an embodiment, operation S220 and operation S230 may be implemented using a large model.

In an embodiment, the above operation S210 may be performed to acquire the memory state by: acquiring a stored memory state in response to a text generation task for the previous text having been executed. The stored memory state is generated based on the previous text of the text to be processed. It may be understood that when the text to be processed is a long text, the long text may be divided into a plurality of text segments, the text to be processed may be any of the plurality of text segments, and the previous text of the text to be processed is a text segment among the plurality of text segments that is adjacent to and before the text to be processed.

For example, in embodiments of the present disclosure, after each text generation task is executed, a memory state may be generated based on the text to be processed, and the memory state may be stored, in association with an identification information of a provider of the text to be processed, into a predetermined storage space. In such embodiments, when acquiring the memory state for the text to be processed, it is possible to determine whether an associated memory state is stored in the predetermined storage space based on the identification information of the provider of the text to be processed. If so, it may be determined that a text generation task for the previous text has been executed, and a latest stored memory state in the associated memory state may be acquired as the memory state for the text to be processed. In this way, even if the provider intermittently provides a plurality of texts to be processed with association relationships for a text generation, the semantic information of the text to be processed that has been provided may be taken into account in the text generation process, which is conducive to improving the accuracy of the generated text and the experience of the text generation.

In an embodiment, if no text generation task has been executed for the previous text, a randomly generated memory state may be used as the memory state for the text to be processed. In such embodiments, it is possible to randomly generate a memory state in advance, which is stored in the predetermined storage space. In a case that it fails to acquire an associated memory state from the predetermined storage space, the randomly generated memory state may be acquired from the predetermined storage space.

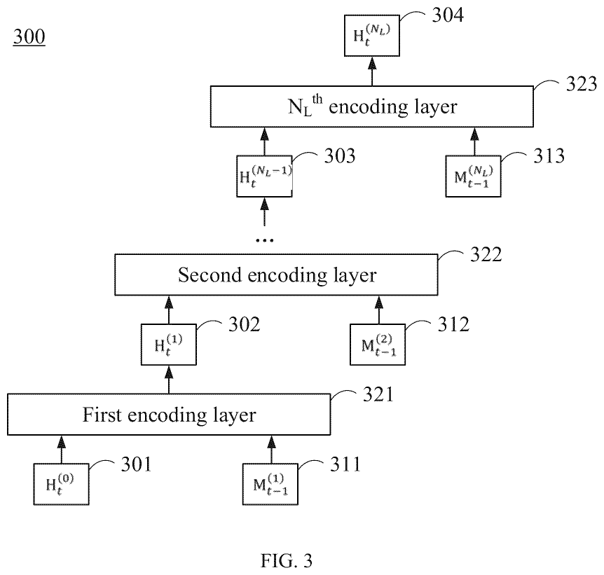

A principle of obtaining the updated hidden state will be further expanded and described with reference to FIG. 3.

FIG. 3 shows a schematic diagram of a principle of obtaining an updated hidden state according to embodiments of the present disclosure.

In an embodiment, the text to be processed may be processed using a recursive method, so that a hierarchical feature in the text to be processed may be learned in the text generation process, that is, different abstract hierarchies of the text to be processed may be captured in different recurrent processes, so that a more complex mathematical expression may be constructed gradually, which is conducive to better understanding the text to be processed and improving the accuracy of the generated subsequent text.

For example, the acquired memory state may include a state sequence formed by a plurality of memory sub-states, and the number of the plurality of memory sub-states may be equal to the number of recursions N_{L} performed to process the text to be processed, where a value of N_{L} may be 2, 4, 6, 8 or other values determined according to actual needs, which is not limited in the present disclosure. A specific recursion process may be as follows. An embedding feature Embedding (Xₜ) of a text to be processed Xₜ is determined as an initial hidden state Hₜ⁽⁰⁾, the initial hidden state Hₜ⁽⁰⁾ and a first memory sub-state Mₜ₋₁⁽¹⁾ among the N_{L} memory sub-states are processed using a first attention mechanism to obtain a next hidden state Hₜ⁽¹⁾ of the initial hidden state Hₜ⁽⁰⁾, then the next hidden state Hₜ⁽¹⁾ may be determined as a current hidden state, and the current hidden state Hₜ⁽¹⁾ and a second memory sub-state Mₜ₋₁⁽²⁾ among the N_{L} memory sub-states are processed using the first attention mechanism to obtain a next hidden state Hₜ⁽²⁾ of the hidden state Hₜ⁽¹⁾. Similarly, a current hidden state Hₜ⁽ⁱ⁻¹⁾ and an i^{th} memory sub-state Mₜ₋₁⁽ⁱ⁾ among the N_{L} memory sub-states may be processed using the first attention mechanism to obtain a next hidden state Hₜ⁽ⁱ⁾ of the current hidden state Hₜ⁽ⁱ⁻¹⁾ until each of the N_{L} memory sub-states is processed, that is, N_{L} recursions are performed, and a next hidden state Hₜ^{(N}^{_{L}}⁾ obtained after the N_{L} recursions are performed is determined as the updated hidden state described above.

In an embodiment, a plurality of encoding layers may be connected (i.e., stacked) in sequence to update the hidden state, and the hidden state output by a last encoding layer may be used as the updated hidden state described above. The plurality of encoding layers may be constructed based on the first attention mechanism. For example, as shown in FIG. 3, in embodiment 300, a total of N_{L} encoding layers may be provided to encode the text to be processed to obtain the updated hidden state. For example, in such embodiment, the initial hidden state Hₜ⁽⁰⁾ 301 and the first sub-state Mₜ₋₁⁽¹⁾ 311 among the N_{L} memory sub-states may be input to a first encoding layer 321 among the plurality of encoding layers connected in sequence, and a first updated hidden state Hₜ⁽¹⁾ 302 is generated by the first encoding layer 321. Then, the first updated hidden state Hₜ⁽¹⁾ 302 and a second sub-state Mₜ₋₁⁽²⁾ 312 among the N_{L} memory sub-states may be input to a second encoding layer 322 among the plurality of encoding layers connected in sequence, and a second updated hidden state Hₜ⁽²⁾ may be generated by the second encoding layer 322. Similarly, an (N_{L}−1)^{th} updated hidden state Hₜ^{(N}^{_{L}}⁻¹⁾ 303 generated by an (N_{L}−1)^{th} encoding layer and an N_{L}^{th} sub-state Mₜ₋₁^{(N}^{_{L}}⁾ 313 among the N_{L} memory sub-states may be input to a last encoding layer (i.e., an N_{L}^{th} encoding layer 323) among the plurality of encoding layers connected in sequence, and an N_{L}^{th} updated hidden state Hₜ^{(N}^{_{L}}⁾ 304 output by the N_{L}^{th} encoding layer 323 may be used as the updated hidden state obtained by operation S220 described above, where i is a natural number less than or equal to N_{L}.

According to embodiments of the present disclosure, the first attention mechanism may be, for example, a unidirectional attention mechanism. A principle of updating the hidden state using the first attention mechanism is shown in Equation (2) below, where Query represents a query feature, KV represents a key feature and a value feature, [,] represents a concat( ) operation on a feature, and Trn_{D}⁽ⁱ⁾ represents an expression function of the first attention mechanism used by an i^{th} encoding layer among the N_{L} encoding layers. That is, when updating the hidden state, the current hidden state is used as the query feature, and a feature obtained by concatenating an i^{th} memory sub-state and the current hidden state is used as the key feature and the value feature.

$${H}_{t}^{( i )} = T r {n}_{D}^{( i )} ( Query = {H}_{t}^{( i - 1 )} , K V = [ {M}_{t - 1}^{( i )} , {H}_{t}^{( i - 1 )} ] ) \qquad Equation ( 2 )$$

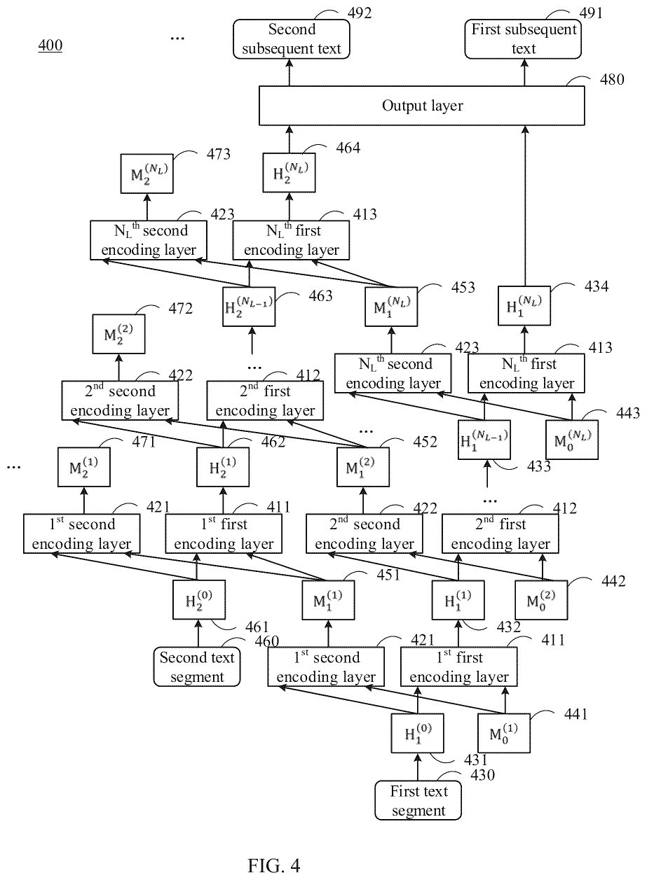

FIG. 4 shows a schematic diagram of an implementation principle of the large model-based method of generating the text according to embodiments of the present disclosure.

According to embodiments of the present disclosure, after a subsequent text for the text to be processed is generated, the memory state may be updated based on the acquired memory state and the hidden state obtained based on the text to be processed, so that a memory state capable of expressing the semantic information of the text to be processed may be acquired when processing the subsequent text of the text to be processed, which is conductive to a long-distance transmission of the semantic information and a generation of infinitely long text with high accuracy.

For example, in such embodiments, the memory state and the initial hidden state may be processed using a second attention mechanism to obtain the updated memory state. In such embodiments, after the updated memory state is obtained, the updated memory state may be stored, for example, in a predetermined storage space, so that a memory state containing the semantic information of the text to be processed may be acquired from the predetermined storage space when processing the subsequent text of the text to be processed. For example, in a case that the memory state for the text to be processed is acquired from the predetermined storage space, such embodiments may be implemented to update the memory state associated with the provider of the text to be processed stored in the predetermined storage space to the obtained updated memory state.

According to embodiments of the present disclosure, the second attention mechanism may be, for example, a bidirectional attention mechanism, which may combine forward and backward context information to capture more comprehensive semantic dependencies. Therefore, by updating the memory state using the bidirectional attention mechanism, the memory state may better express a long-distance semantic dependency, which is conductive to improving the accuracy of the subsequent text generated based on the memory state.

In an embodiment, it is possible to obtain each sub-state in the updated memory state using a recursive method, so that the updated memory state may express a hierarchical feature of the text to be processed and more accurately represent the semantic information of the text to be processed, which is conductive to improving a processing effect on the text to be processed provided subsequently and the accuracy of the generated subsequent text.

For example, the acquired memory state may include a state sequence formed by a plurality of memory sub-states, and the number of the plurality of memory sub-states may be equal to the number of recursions performed to update the memory state. The number of recursions performed to update the memory state may be equal to the number of recursions N_{L} performed to process the text to be processed as described earlier. A process of updating the memory state through recursions may be as follows. An initial hidden state Hₜ⁽⁰⁾ (which may be understood as a 0^{th} hidden state) and a first memory sub-state Mₜ₋₁⁽¹⁾ in the state sequence are processed using the second attention mechanism to obtain a first memory sub-state Mₜ⁽¹⁾ in the updated memory state. A first hidden state Hₜ⁽¹⁾ obtained in a process of obtaining the updated hidden state and a second memory sub-state Mₜ₋₁⁽²⁾ in the state sequence are processed using the second attention mechanism to obtain a second memory sub-state Mₜ⁽²⁾ in the updated memory state. Similarly, an (i−1)^{th} hidden state Hₜ⁽ⁱ⁻¹⁾ obtained in the process of obtaining the updated hidden state and an i^{th} memory sub-state Mₜ₋₁⁽ⁱ⁾ in the state sequence may be processed using the second attention mechanism to obtain an i^{th} memory sub-state Mₜ⁽ⁱ⁾ the updated memory state, until an N_{L}^{th} memory sub-state Mₜ^{(N}^{_{L}}⁾ in the updated memory state is obtained.

According to embodiments of the present disclosure, a principle of updating the memory state using the second attention mechanism is shown in Equation (3) below, where Trn_{E}⁽ⁱ⁾ represents an expression function of the second attention mechanism used in the N_{L} recursions. That is, when updating the memory state, the current memory state is used as the query feature, and a feature obtained by concatenating the i^{th} memory sub-state and the (i−1)^{th} hidden state obtained in sequence is used as the key feature and the value feature.

$${M}_{t}^{( i )} = T r {n}_{D}^{( i )} ( Query = {M}_{t}^{( i - 1 )} , K V = [ {M}_{t - 1}^{( i )} , {H}_{t}^{( i - 1 )} ] ) \qquad Equation ( 3 )$$

In an embodiment, it is possible to provide a plurality of encoding layers to update the memory state. The plurality of encoding layers may be constructed based on the second attention mechanism, and each encoding layer may output a memory sub-state in the updated memory state.

In an embodiment, when the text to be processed is a long text, if the generated subsequent text has a text length greater than a predetermined length, it is possible to obtain the updated memory state using the second attention mechanism, without waiting for a complete generation of all subsequent texts for the text to be processed. The predetermined length may be determined based on an encoding length limit of the attention mechanism, or may be determined according to actual needs, which is not limited in the present disclosure. By setting the predetermined length, it is possible to ensure an effective transmission of semantic information, avoid failing to effectively learn a contextual semantic information of the text to be processed due to a too large length of the text to be processed, and thus ensure the accuracy of the generated subsequent text.

As shown in FIG. 4, in embodiment 400, it is possible to provide a plurality of first encoding layers connected in sequence and a plurality of second encoding layers connected in sequence to process the text to be processed, so as to obtain the updated hidden state and the updated memory state. In embodiment 400, the text to be processed may be, for example, a long text. Embodiment 400 may be implemented to pre-divide the text to be processed into a plurality of text segments with a sequential order. Except for a last text segment, each text segment may have, for example, a text length of N, that is, each text segment may be divided into N tokens. In such embodiments, the plurality of text segments with a sequential order may be sequentially processed, and the memory state may be updated once after each generation of a subsequent text for a text segment.

For example, as shown in FIG. 4, the text to be processed is divided into T text segments. In embodiment 400, when performing a text generation task for the text to be processed, it is possible to perform a text generation task on a first text segment 430, and acquire a randomly generated memory state that may be expressed as a state sequence {M₀⁽¹⁾, M₀⁽²⁾, . . . , M₀^{(N}^{_{L}}⁾}. When performing a text generation task on the first text segment 430, it is possible to determine an embedding feature of the first text segment 430 as an initial hidden state H₁⁽⁰⁾ 431, then process the initial hidden state H₁⁽⁰⁾ 431 and a memory sub-state M₀⁽¹⁾ 441 based on the first attention mechanism by using a 1^{st} first encoding layer 411 among the stacked plurality of first encoding layers, so as to obtain a hidden state H₁⁽¹⁾ 432. Then, the hidden state H₁⁽¹⁾ 432 and a memory sub-state M₀⁽²⁾ 442 may be processed based on the first attention mechanism by using a 2^{nd} first encoding layer 412, so as to obtain a hidden state H₁⁽²⁾. Similarly, a hidden state H₁^{(N}^{_{L}}⁻¹⁾ 433 and a memory sub-state M₀^{(N}^{_{L}}⁾ 443 may be processed based on the first attention mechanism by using an N_{L}^{th} first encoding layer 413, so as to obtain a hidden state H₁^{(N}^{_{L}}⁾ 434. The hidden state H₁^{(N}^{_{L}}⁾ 434 is the updated hidden state obtained by processing the first text segment 430 and the memory state. Meanwhile, the initial hidden state H₁⁽⁰⁾ 431 and the memory sub-state M₀⁽¹⁾ 441 may be processed based on the second attention mechanism by using a 1^{st} second encoding layer 421 among the plurality of second encoding layers, so as to obtain a first memory sub-state M₁⁽¹⁾ 451 in the updated memory state. And then, the hidden state H₁⁽¹⁾ 432 and the memory sub-state M₀⁽²⁾ 442 may be processed based on the second attention mechanism by using a 2^{nd} second encoding layer 422, so as to obtain a second memory sub-state M₁⁽²⁾ 452 in the updated memory state. Similarly, a hidden state H₁^{(N}^{_{L}}⁻¹⁾ 433 and a memory sub-state M₀^{(N}^{_{L}}⁾ 443 may be processed based on the second attention mechanism by using an N_{L}^{th} second encoding layer 423, so as to obtain an N_{L}^{th} memory sub-state M₁^{(N}^{_{L}}⁾ 453 in the updated memory state. In this way, an updated memory state {M₁⁽¹⁾, M₁⁽²⁾, . . . , M₁^{(N}^{_{L}}⁾} may be obtained. The updated memory state may be used as a memory state for a second text segment among the T text segments. The randomly generated memory state may be, for example, a tensor with a size of M×N_{L}×D, where M represents a length of the memorized tokens, and D represents a dimension of a semantic feature of each memorized token. By unfolding the tensor, a state sequence may be obtained, and each memory sub-state in the state sequence has a size of M×D.

Similarly, when performing a text generation task on the second text segment 460, it is possible to determine an embedding feature of the second text segment 460 as an initial hidden state H₂⁽⁰⁾ 461. Then, the initial hidden state H₂⁽⁰⁾ 461 and a memory sub-state M₁⁽¹⁾ 451 may be processed based on the first attention mechanism by using the 1^{st} first encoding layer 411 among the stacked plurality of first encoding layers, so as to obtain a hidden state H₂⁽¹⁾ 462. And then, the hidden state H₂⁽¹⁾ 462 and the memory sub-state M₁⁽²⁾ 452 may be processed based on the first attention mechanism by using the 2^{nd} first encoding layer 412, so as to obtain a hidden state H₁⁽²⁾. Similarly, a hidden state H₂^{(N}^{_{L}}⁻¹⁾ 463 and a memory sub-state M₁^{(N}^{_{L}}⁾ 453 may be processed based on the first attention mechanism by using the N_{L}^{th} first encoding layer 413, so as to obtain a hidden state H₂^{(N}^{_{L}}⁾ 464. The hidden state H₂^{(N}^{_{L}}⁾ 464 is the updated hidden state obtained by processing the second text segment 460 and the memory state. Meanwhile, the initial hidden state H₂⁽⁰⁾ 461 and the memory sub-state M₁⁽¹⁾ 451 may be processed based on the second attention mechanism by using the 1^{st} second encoding layer 421 among the plurality of second encoding layers, so as to obtain a first memory sub-state M₂⁽¹⁾ 471 in the updated memory state. Then, the hidden state H₂⁽¹⁾ 462 and the memory sub-state M₁⁽²⁾ 452 may be processed based on the second attention mechanism by using the 2^{nd} second encoding layer 422, so as to obtain a second memory sub-state M₂⁽²⁾ 472 in the updated memory state. Similarly, the hidden state H₂^{(N}^{_{L}}⁻¹⁾ 463 and the memory sub-state M₁^{(N}^{_{L}}⁾ 453 may be processed based on the second attention mechanism by using the N_{L}^{th} second encoding layer 423, so as to obtain an N_{L}^{th} memory sub-state M₂^{(N}^{_{L}}⁾ 473 in the updated memory state. In this way, an updated memory state {M₂⁽¹⁾, M₂⁽²⁾, . . . , M₂^{(N}^{_{L}}⁾} may be obtained. The updated memory state may be used as a memory state for a third text segment among the T text segments. Similarly, text generation tasks may be performed for all T text segments.

According to embodiments of the present disclosure, after obtaining the updated hidden state H₁^{(N}^{_{L}}⁾ 434 by performing the text generation task for the first text segment 430, the updated hidden state. H₁^{(N}^{_{L}}⁾ 434 may be processed using an output layer 480, so as to obtain a subsequent text for the first text segment 430, namely a first subsequent text 491. Similarly, after obtaining the updated hidden state H₂^{(N}^{_{L}}⁾ 464 by performing the text generation task for the second text segment 460, the updated hidden state H₂^{(N}^{_{L}}⁾ 464 may be processed using the output layer 480, so as to obtain a subsequent text for the second text segment 460, namely a second subsequent text 492. Similarly, a subsequent text for a T^{th} text segment may be obtained.

According to embodiments of the present disclosure, the output layer 480 may process the updated hidden state using the softmax function described in Equation (1), which is not limited in the present disclosure.

In an embodiment, the hidden state may have the same size as the memory sub-state, and the memory sub-state may be understood as a special hidden state.

Through the large model-based method of generating the text in embodiments of the present disclosure, an upper limit of inference cost for a long text with a length L is Θ((N+M)·L), and the inference cost of text generation may be greatly reduced compared to the inference cost Θ(L²) of an existing mainstream text generation model. Furthermore, through the update of the memory state, a technical solution of a text generation model processing a text of an arbitrary length to generate a text may be achieved, and an inference efficiency and an inference effect may be ensured.

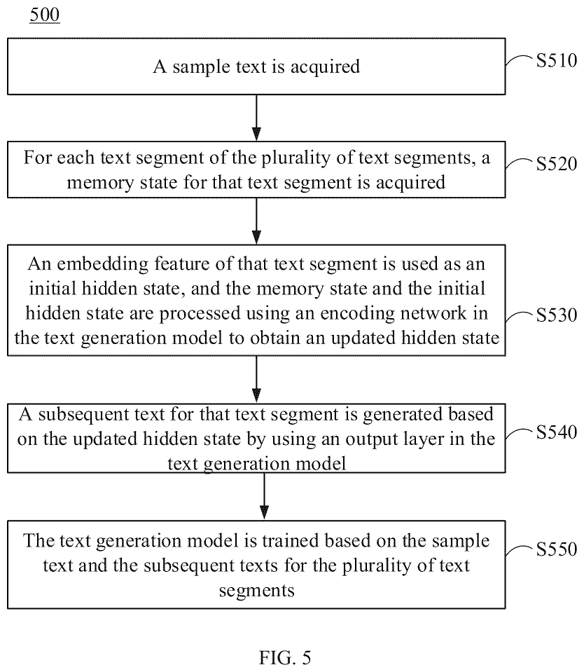

In order to facilitate an implementation of the large model-based method of generating the text, the present disclosure further provides a method of training a text generation model. The training method will be described in detail below with reference to FIG. 5.

FIG. 5 shows a schematic flowchart of a method of training a text generation model according to embodiments of the present disclosure.

As shown in FIG. 5, a method 500 of training a text generation model in such embodiments may include operation S510 to operation S550.

In operation S510, a sample text is acquired.

According to embodiments of the present disclosure, each sample text may include, for example, a plurality of text segments obtained by dividing a long text. The long text may refer to, for example, a text with a text length greater than a predetermined length. The predetermined length is similar to the predetermined length described above, which will not be repeated here.

In operation S520, for each text segment of the plurality of text segments, a memory state for that text segment is acquired.

In operation S520, each text segment may be used as a text to be processed, and the memory state for the text to be processed may be acquired. It may be understood that an implementation principle of operation S520 is similar to that of operation S210 described above, which will not be repeated here.

In operation S530, an embedding feature of that text segment is used as an initial hidden state, and the memory state and the initial hidden state are processed using an encoding network in the text generation model to obtain an updated hidden state.

The encoding network may be a network constructed based on the first attention mechanism, that is, the encoding network may process the memory state and the initial hidden state using the first attention mechanism. The encoding network may include one encoding layer or a plurality of encoding layers connected in sequence, which is not limited in the present disclosure. A principle of processing the memory state and the initial hidden state using the encoding network in operation S530 is similar to the implementation principle of operation S220 described above, which will not be repeated here.

In operation S540, a subsequent text for that text segment is generated based on the updated hidden state by using an output layer in the text generation model.

The output layer may be a network layer constructed based on a normalization function (such as softmax function). An implementation principle of operation S540 is similar to that of operation S230 described above, which will not be repeated here.

In operation S550, the text generation model is trained based on the sample text and the subsequent texts for the plurality of text segments.

According to embodiments of the present disclosure, a t^{th} text segment Xₜ among the plurality of text segments may be expressed as, for example, a token sequence {x_{t,1}, x_{t,2}, . . . , x_{t,N}}. A goal of training the text generation model is to predict a second token in the t^{th} text segment based on a first token in the t^{th} text segment. Accordingly, for the t^{th} text segment, the generated subsequent text may be expressed by, for example, a token sequence {x_{t,2}′, x_{t,3}′, . . . , x_{t,N}′, x_{t+1,1}′}. That is, the subsequent text generated for the t^{th} text segment includes the predicted second to N^{th} tokens in the t^{th} text segment Xₜ as well as a first token in a (t+1)^{th} text segment Xₜ₊₁. In this way, the tokens in the sample text other than the first token may be used as truth values for training the text generation model, so that self-supervised training of the text generation model may be achieved.

For example, in such embodiments, a loss value generated by the text generation model when performing a text generation task for the t^{th} text segment may be calculated using Equation (4), and CrossEntropy( ) in Equation (4) represents a cross entropy loss function. In such embodiments, the function expressed by Equation (4) may be used as an objective function, and the text generation model is trained with a goal of minimizing the objective function.

$${L}_{t} = CrossEntropy ( \text{} \{ {x}_{t , 2}^{′} , {x}_{t , 3}^{′} , … , {x}_{t , N}^{′} , {x}_{t + 1 , 1}^{′} \} , \{ {x}_{t , 2} , {x}_{t , 3} , … , {x}_{t , N} , {x}_{t + 1 , 1} \} ) \qquad Equation ( 4 )$$

Such embodiments may be implemented to obtain losses for a plurality of text segments using Equation (4), determine a sum of the obtained plurality of loss values as a total loss of the text generation model, and train the text generation model with a goal of minimizing the total loss. It may be understood that the cross entropy loss function used for calculating the loss value is merely an example to facilitate understanding of the present disclosure, which is not limited in the present disclosure.

According to embodiments of the present disclosure, the above-described memory state may include a state sequence formed by a plurality of memory sub-states. The encoding network may include a first encoding sub-network, which includes a plurality of first encoding layers connected in sequence and constructed based on the first attention mechanism, such as N_{L} encoding layers described above in embodiment 300. In such embodiments, operation S530 described above may be performed according to the following principle. The embedding feature of each text segment is determined as the initial hidden state, a current hidden state and an i^{th} memory sub-state in the state sequence are processed using an i^{th} encoding layer among the plurality of first encoding layers, so as to obtain a next hidden state of the current hidden state, where the updated hidden state is a next hidden state obtained by a last encoding layer among the plurality of first encoding layers. The implementation principle is similar to that described in embodiment 300, which will not be repeated here.

According to embodiments of the present disclosure, when a text segment to be currently processed is a first one of the plurality of text segments, a randomly generated memory state may be acquired as the memory state for the text segment to be currently processed. When the text segment to be currently processed is a text segment other than the first one of the plurality of text segments, a stored memory state may be acquired. The stored memory state is obtained based on previous text segment(s) (for example, one previous text segment) of each text segment among the plurality of text segments.

According to embodiments of the present disclosure, the encoding network may further include a second encoding sub-network constructed based on the second attention mechanism. In a process of training the text generation model, it is possible to process the memory state and the initial hidden state using the second encoding sub-network to obtain an updated memory state, and then update the stored memory state to the updated memory state. The second attention mechanism may be a bidirectional attention mechanism, and the above-described first attention mechanism may be a unidirectional attention mechanism.

According to embodiments of the present disclosure, the memory state may include a state sequence formed by a plurality of memory sub-states, and the updated hidden state is a last one of the plurality of hidden states obtained in sequence. The second encoding sub-network may include a plurality of second encoding layers constructed based on the second attention mechanism, such as the N_{L} second encoding layers described above in embodiment 400. An implementation principle of processing the memory state and the initial hidden state using the second encoding sub-network to obtain the updated memory state may be, for example, processing an i^{th} memory sub-state in the state sequence and an obtained (i−1)^{th} hidden state by using an i^{th} one of the plurality of second encoding layers to obtain an i^{th} memory sub-state in the updated memory state. The implementation principle of obtaining the updated memory state may be for example referred to embodiment 400 described above, which will not be repeated here.

According to embodiments of the present disclosure, the function for calculating the loss value may be used as the objective function to train the text generation model. A gradient of the objective function may be back-propagated using a back-propagation algorithm. Then, with a goal of minimizing the objective function, the text generation model is trained based on the gradient obtained by back-propagation. The back-propagation algorithm is for example used to calculate and store gradients of the objective function related to intermediate variables and parameters of each layer in the text generation model, in an order from the output layer to the input layer of the text generation model according to a chain rule in calculus. Such embodiments may be implemented to determine an adjustment direction and an adjustment amount of network parameters in the text generation model based on the calculated and stored gradients, and adjust the network parameters based thereon to optimize the text generation model.

In an embodiment, a gradient back-propagation of the objective function may be performed using a back-propagation through time algorithm, so as to unfold the text generation model in time steps, thereby obtaining a dependency relationship between model variables and network parameters of the text generation model, and calculating and storing the gradients using back-propagation according to the chain rule.

It may be understood that the objective function is related to a difference between the subsequent texts for the plurality of text segments and a target text in the sample text, and the target text is a text corresponding to the subsequent text in the sample text. For example, the objective function may be obtained based on Equation (4) described above.

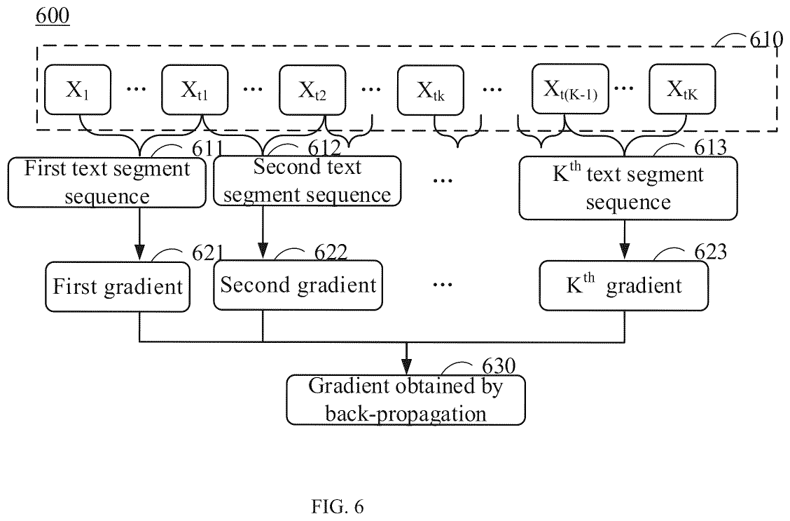

FIG. 6 shows a schematic diagram of a principle of back-propagating a gradient of an objective function according to embodiments of the present disclosure.

According to embodiments of the present disclosure, it is possible to preset a gradient clip point for a plurality of text segments, that is, to select a target text segment from the plurality of text segments, and when the gradient is back-propagated to the target text segment, the back-propagation is not continued, so as to prevent excessive gradients from being recorded in the back-propagation process to cause a video memory explosion.

For example, as shown in FIG. 6, in embodiment 600, it is possible to determine clip points {t1, . . . tk, . . . tK}, that is, a t1^{th} text segment, a tk^{th} text segment and a tK^{th} text segment among T text segments 610 are determined as target text segments, t1, . . . tk, . . . tK∈[1, T]. In such embodiments, when the back-propagation proceeds to the target text segment among the plurality of text segments, a text segment sequence formed by two adjacent target text segments that the back-propagation has proceeded to and a text segment located between the two adjacent target text segments is determined. For example, it is possible to obtain a first text segment sequence {X₁, X₂, . . . , Xₜ₁} 611, a second text segment sequence {Xₜ₁, Xₜ₁₊₁, . . . , Xₜ₂} 612, . . . , {Xₜₖ, Xₜₖ₊₁, . . . , X_{t (k+1)}}, and a K^{th} text segment sequence {X_{t (K-1)}, X_{t (K-1)+1}, . . . , X_{tK}} 613. It may be understood that the target text segments include a last text segment X_{T} among the T text segments. For example, the target text segment X_{tK} is actually the text segment X_{T}. The target text segments may also include the first text segment X₁, as the gradient may be naturally clipped after being back-propagated to the first text segment. Then, such embodiments may be implemented to back-propagate the gradient of the objective function within each text segment sequence by using back-propagation through time algorithm to obtain a gradient as the gradient for the target text segment that the back-propagation currently proceeds to. For example, it is possible to obtain a first gradient 621 for the text segment X₁ by back-propagating the gradient of the objective function within the first text segment sequence 611, obtain a second gradient 622 for the text segment Xₜ₁ by back-propagating the gradient of the objective function within the second text segment sequence 612, and obtain a K^{th} gradient 623 for the text segment X_{t(K-1)} by back-propagating the gradient of the objective function within the Kₜₕ text segment sequence 613.

For example, when back-propagating the gradient of the objective function within a text segment sequence, it is possible to calculate a sum of losses generated by the text generation model in performing the text generation task for the text segments within the text segment sequence. For example, for a k^{th} text segment, a sum of losses L=Σ_{t∈[t}_{ₖ}_{,t}_{ₖ₊₁}_{]}Lₜ may be calculated. And then, it is possible to take a derivative of the sum of losses with respect to all network parameters of the text generation model to obtain a derivative GP_{L}. In such embodiments, the derivative GP_{L} may be used as the gradient for the target text segment Xₜ_{ₖ}.

After the gradients for all target text segments that the back-propagation proceeds to are obtained, a sum of all obtained gradients may be used as a gradient 630 obtained by back-propagation. Then the text generation model may be trained based on the gradient. It may be understood that, no gradient back-propagation and calculation is performed on the last text segment X_{T} that the back-propagation proceeds to, as the last text segment X_{T} doesn't have two adjacent target text segments that the back-propagation proceeds to.

According to embodiments of the present disclosure, in order to achieve clip of the gradient back-propagation, the memory state Mₜ_{ₖ}⁽ⁱ⁾ may be considered as a parameter during the gradient back-propagation in such embodiments. In this way, when the gradient is back-propagated to Mₜ_{ₖ}⁽ⁱ⁾, the gradient back-propagation may be automatically clip.

It may be understood that the specific principle of back-propagating the gradient of the objective function described above is merely an example to facilitate understanding of the present disclosure, and does not constitute a limitation to the present disclosure.

In an embodiment, a direct gradient clip may result in a decrease in a training effect of the model. In such embodiments, in order to avoid a decrease in the training effect of the model, it is also possible to take a derivative of the memory state of the previous target text segment that the back-propagation has proceeded to of the target text segment that the back-propagation currently proceeds to, so as to obtain the gradient of the memory state. Then, it is possible to determine an influence degree of a text segment after the previous target text segment that the back-propagation has proceeded to on the gradient for the target text segment that the back-propagation currently proceeds to, based on the gradient and a change in the memory state for the previous target text segment that the back-propagation has proceeded to. It may be understood that the change in the memory state for the previous target text segment that the back-propagation has proceeded to may be obtained by back-propagating the gradient of the objective function within a text segment after the previous target text segment that the back-propagation has proceeded to. And then, the back-propagated gradient obtained by taking derivative of the loss is adjusted based on the influence degree. In this way, the training effect of the model may not be affected by the gradient clip, which may avoid a video memory explosion while ensuring the training effect of the model.

For example, a product of the gradient of the memory state and the change in the memory state for the previous target text segment that the back-propagation has proceeded to may be used as the influence degree.

In an embodiment, ΔM_{tK}⁽ⁱ⁾=0, that is, the change in the memory state for the last text segment among the T text segments is zero. This is because there are no other text segments after the last text segment. When determining the gradient for the target text segment Xₜₖ, in addition to taking a derivative of the sum of losses L=Σ_{t∈[t}_{ₖ}_{,t}_{ₖ₊₁}_{]}Lₜ with respect to all network parameters of the text generation model to obtain a derivative GP_{L}, it is also possible to take a derivative of Mₜ₍ₖ₊₁₎⁽ⁱ⁾ with respect to all network parameters of the text generation model to obtain a derivative GP_{M}. Then, a gradient ΔPₖ for a target text segment Xₜₖ that the back-propagation currently proceeds to may be calculated using Equation (5) below, where ΔMₜ₍ₖ₊₁₎⁽ⁱ⁾ represents a change in the memory state Mₜ₍ₖ₊₁₎⁽ⁱ⁾ for the target text segment Xₜ₍ₖ₊₁₎.

$$Δ {P}_{k} = Δ {M}_{{t}_{k + 1}}^{( l )} \cdot {GP}_{M} + G {P}_{L} \qquad Equation ( 5 )$$

Finally, such embodiments may be implemented to calculate a sum of all gradients obtained by back-propagation, ΔP=ΣₖΔPₖ, to obtain a gradient obtained by back-propagation.

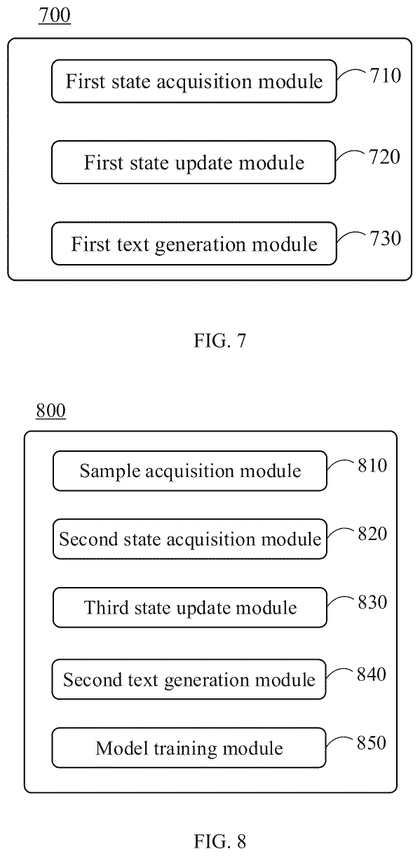

Based on the large model-based method of generating the text provided in the present disclosure, the present disclosure further provides a large model-based apparatus of generating a text, which will be described in detail below with reference to FIG. 7.

FIG. 7 shows a structural block diagram of a large model-based apparatus of generating a text according to embodiments of the present disclosure.

As shown in FIG. 7, a large model-based apparatus 700 of generating a text in such embodiments may include a first state acquisition module 710, a first state update module 720, and a first text generation module 730.

The first state acquisition module 710 is used to acquire a memory state for a text to be processed. The memory state is generated based on a previous text of the text to be processed. In an embodiment, the first state acquisition module 710 may be used to perform operation S210 described above, which will not be described in detail here.

The first state update module 720 is used to determine an embedding feature of the text to be processed as an initial hidden state, and process the memory state and the initial hidden state by using a first attention mechanism to obtain an updated hidden state. In an embodiment, the first state update module 720 may be used to perform operation S220 described above, which will not be described in detail here.

The first text generation module 730 is used to generate a subsequent text for the text to be processed based on the updated hidden state. In an embodiment, the first text generation module 730 may be used to perform operation S230 described above, which will not be described in detail here.

According to embodiments of the present disclosure, the memory state includes a state sequence formed by a plurality of memory sub-states. The first state update module 720 may include: a state determination sub-module used to process, with the embedding feature of the text to be processed as the initial hidden state, an i^{th} memory sub-state in the state sequence and a current hidden state by using the first attention mechanism to obtain a next hidden state of the current hidden state; a first update sub-module used to update the current hidden state to the next hidden state and setting i to i+1 in response to the plurality of memory sub-states comprising an unprocessed memory sub-state; and a second update sub-module used to determine the next hidden state as the updated hidden state in response to the plurality of memory sub-states not comprising the unprocessed memory sub-state, where i is a natural number less than or equal to a total number of the plurality of memory sub-states.

According to embodiments of the present disclosure, the first state acquisition module 710 may include: a first acquisition sub-module used to acquire a stored memory state in response to a text generation task for the previous text having been executed, where the stored memory state is generated based on the previous text; and a second acquisition sub-module used to acquire a randomly generated memory state in response to not having executed the text generation task for the previous text.

According to embodiments of the present disclosure, the text generation apparatus 700 may further include: a second state update module used to process the memory state and the initial hidden state by using a second attention mechanism to obtain an updated memory state in response to the generated subsequent text having a text length greater than a predetermined length; and a storage update module used to update the stored memory state to the updated memory state, where the first attention mechanism is a unidirectional attention mechanism, and the second attention mechanism is a bidirectional attention mechanism.

According to embodiments of the present disclosure, the memory state includes a state sequence formed by a plurality of memory sub-states, the updated hidden state is a last hidden state among a plurality of hidden states obtained in sequence. The second state update module is may be for example used to: process an i^{th} memory sub-state in the state sequence and an obtained (i−1)^{th} hidden state by using the second attention mechanism to obtain an i^{th} memory sub-state in the updated memory state, where i is a natural number less than or equal to a total number of the plurality of memory sub-states, and a first memory sub-state is obtained by processing the initial hidden state.

Based on the method of training the text generation model provided in the present disclosure, the present disclosure further provides an apparatus of training a text generation model, which will be described in detail below with reference to FIG. 8.

As shown in FIG. 8, an apparatus 800 of training a text generation model in such embodiments may include a sample acquisition module 810, a second state acquisition module 820, a third state update module 830, a second text generation module 840, and a model training module 850.

The sample acquisition module 810 is used to acquire a sample text, where each sample text includes a plurality of text segments obtained by dividing a long text. In an embodiment, the sample acquisition module 810 may be used to perform operation S510 described above, which will not be described in detail here.

The first state acquisition module 820 is used to, for each text segment of the plurality of text segments, acquire a memory state for the text segment, where the memory state is generated based on a previous text of the text segment. In an embodiment, the first state acquisition module 820 may be used to perform operation S520 described above, which will not be described in detail here.

The third state update module 830 is used to determine an embedding feature of the text segment as an initial hidden state, and process the memory state and the initial hidden state by using an encoding network in the text generation model to obtain an updated hidden state. In an embodiment, the third state update module 830 may be used to perform operation S530 described above, which will not be described in detail here.

The first text generation module 840 is used to generate, based on the updated hidden state, a subsequent text for the text segment by using an output layer in the text generation model. In an embodiment, the first text generation module 840 may be used to perform operation S540 described above, which will not be described in detail here.

The model training module 850 is used to train the text generation model based on the sample text and the subsequent texts for the plurality of text segments. In an embodiment, the model training module 850 may be used to perform operation S550 described above, which will not be described in detail here.

According to embodiments of the present disclosure, the memory state includes a state sequence formed by a plurality of memory sub-states, the encoding network includes a first encoding sub-network, the first encoding sub-network includes a plurality of first encoding layers connected in sequence and constructed based on the first attention mechanism. The third state update module 830 may be for example used to: process, with the embedding feature of the text segment as the initial hidden state, an i^{th} memory sub-state in the state sequence and a current hidden state by using an i^{th} encoding layer among the plurality of first encoding layers to obtain a next hidden state of the current hidden state, where the updated hidden state is the next hidden state obtained by a last encoding layer among the plurality of first encoding layers, and i is a natural number less than or equal to a total number of the plurality of memory sub-states.

According to embodiments of the present disclosure, the second state acquisition module 820 may include: a third acquisition sub-module used to acquire a randomly generated memory state in response to the text segment being a first text segment among the plurality of text segments; and a fourth acquisition sub-module used to acquire a stored memory state in response to the text segment being a text segment among the plurality of text segments other than the first text segment, where the stored memory state is obtained based on a previous text segment of the text segment among the plurality of text segments.

According to embodiments of the present disclosure, the encoding network further includes a second encoding sub-network constructed based on a second attention mechanism. The apparatus 800 of training the text generation model may further include: a fourth state update module used to process the memory state and the initial hidden state by using the second encoding sub-network to obtain an updated memory state; and a second storage update module used to update the stored memory state to the updated memory state, where the first attention mechanism is a unidirectional attention mechanism, and the second attention mechanism is a bidirectional attention mechanism.

According to embodiments of the present disclosure, the memory state includes a state sequence formed by a plurality of memory sub-states, the updated hidden state is a last hidden state among a plurality of hidden states obtained in sequence, the second encoding sub-network includes a plurality of second encoding layers constructed based on the second attention mechanism. The fourth state update module may be for example used to: process an i^{th} memory sub-state in the state sequence and an obtained (i−1)^{th} hidden state by using an i^{th} second encoding layer among the plurality of second encoding layers to obtain an i^{th} memory sub-state in the updated memory state, where i is a natural number less than or equal to a total number of the plurality of memory sub-states, and a hidden state processed by a 1^{st} second encoding layer is the initial hidden state.

According to embodiments of the present disclosure, the model training model 850 may include: a gradient back-propagation sub-module used to back-propagate a gradient of an objective function by using a back-propagation through time algorithm; and a training sub-module used to train the text generation model based on a gradient obtained by a back-propagation, with a goal of minimizing the objective function, where the objective function is related to a difference between the subsequent texts for the plurality of text segments and a target text in the sample text, and the target text is a text corresponding to the subsequent text.

According to embodiments of the present disclosure, the gradient back-propagation sub-module may include: a sequence determination unit configured to determine, in response to the back-propagation proceeding to a target text segment among the plurality of text segments, a text segment sequence formed by two adjacent target text segments that the back-propagation has proceeded to and a text segment between the two adjacent target text segments, where the target text segment includes a last text segment among the plurality of text segments, and a number of target text segments is multiple; a gradient back-propagation unit used to back-propagate the gradient of the objective function within the text segment sequence by using the back-propagation through time algorithm to determine a gradient for a target text segment that the back-propagation currently proceeds to; and a gradient determination unit used to determine the gradient obtained by the back-propagation based on a sum of a plurality of gradients for a plurality of target text segments.

According to embodiments of the present disclosure, the apparatus of training the text generation model may further include: a state determination module used to determine, in response to the back-propagation proceeding to a target text segment, a memory state acquired for a previous target text segment that the back-propagation has proceeded to of the target text segment that the back-propagation currently proceeds to as a target state; a gradient determination module used to determine a gradient of the target state; and an influence degree determination module used to determine, based on the gradient of the target state and a change of the target state to the previous target text segment that the back-propagation has proceeded to, an influence degree of a text segment after the previous target text segment that the back-propagation has proceeded to among the plurality of text segments on the gradient for the target text segment that the back-propagation currently proceeds to, where the gradient for the target text segment that the back-propagation currently proceeds to is determined based on a sum of the influence degree and a gradient obtained by back-propagating the gradient of the objective function within the text segment sequence.

It should be noted that in technical solutions of the present disclosure, a collection, a storage, a use, a processing, a transmission, a provision, a disclosure and other processing of user personal information involved comply with provisions of relevant laws and regulations, take necessary security measures, and do not violate public order and good custom. In the technical solutions of the present disclosure, the acquisition or collection of user personal information has been authorized or allowed by users.

According to embodiments of the present disclosure, the present disclosure further provides an electronic device, a readable storage medium, and a computer program product.

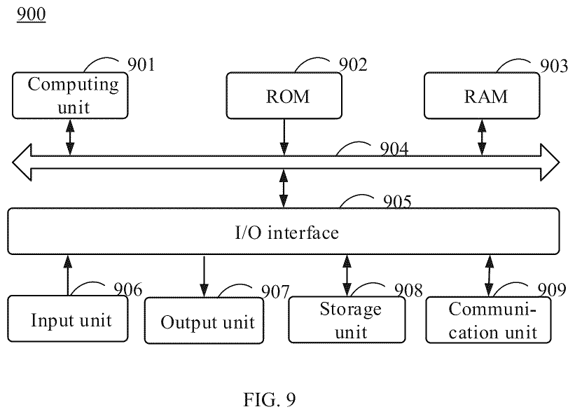

FIG. 9 shows a schematic block diagram of an example electronic device 900 for implementing the large model-based method of generating the text or the method of training the text generation model in embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the electronic device 900 includes a computing unit 901 which may perform various appropriate actions and processes according to a computer program stored in a read only memory (ROM) 902 or a computer program loaded from a storage unit 908 into a random access memory (RAM) 903. In the RAM 903, various programs and data necessary for an operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, or a mouse; an output unit 907, such as displays or speakers of various types; a storage unit 908, such as a disk, or an optical disc; and a communication unit 909, such as a network card, a modem, or a wireless communication transceiver. The communication unit 909 allows the electronic device 900 to exchange information/data with other devices through a computer network such as Internet and/or various telecommunication networks.

The computing unit 901 may be various general-purpose and/or dedicated processing assemblies having processing and computing capabilities. Some examples of the computing units 901 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 901 executes various methods and processes described above, such as the large model-based method of generating the text or the method of training the text generation model. For example, in some embodiments, the large model-based method of generating the text or the method of training the text generation model may be implemented as a computer software program which is tangibly embodied in a machine-readable medium, such as the storage unit 908. In some embodiments, the computer program may be partially or entirely loaded and/or installed in the electronic device 900 via the ROM 902 and/or the communication unit 909. The computer program, when loaded in the RAM 903 and executed by the computing unit 901, may execute one or more steps in the large model-based method of generating the text or the method of training the text generation model described above. Alternatively, in other embodiments, the computing unit 901 may be used to perform the large model-based method of generating the text or the method of training the text generation model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the large model-based method of generating the text or the method of training the text generation model of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, also known as a cloud computing server or a cloud host, which is a host product in a cloud computing service system to solve shortcomings of difficult management and weak service scalability existing in a conventional physical host and VPS (Virtual Private Server) service. The server may also be a server of a distributed system or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-described specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A large model-based method of generating a text, comprising:
acquiring a memory state for a text to be processed, wherein the memory state is generated based on a previous text of the text to be processed;
determining an embedding feature of the text to be processed as an initial hidden state, and processing the memory state and the initial hidden state by using a first attention mechanism to obtain an updated hidden state; and
generating a subsequent text for the text to be processed based on the updated hidden state.

2. The method according to claim 1, wherein the memory state comprises a state sequence formed by a plurality of memory sub-states, and the processing the memory state and the initial hidden state by using a first attention mechanism to obtain an updated hidden state comprises:
processing, with the embedding feature of the text to be processed as the initial hidden state, an i^{th} memory sub-state in the state sequence and a current hidden state by using the first attention mechanism to obtain a next hidden state of the current hidden state;
updating the current hidden state to the next hidden state and setting i to i+1, in response to the plurality of memory sub-states comprising an unprocessed memory sub-state; and
determining the next hidden state as the updated hidden state, in response to the plurality of memory sub-states not comprising the unprocessed memory sub-state,
wherein i is a natural number less than or equal to a total number of the plurality of memory sub-states.

3. The method according to claim 1, wherein the acquiring a memory state for a text to be processed comprises:
acquiring a stored memory state in response to a text generation task for the previous text having been executed, wherein the stored memory state is generated based on the previous text; and
acquiring a randomly generated memory state in response to not having executed the text generation task for the previous text.

4. The method according to claim 2, wherein the acquiring a memory state for a text to be processed comprises:
acquiring a stored memory state in response to a text generation task for the previous text having been executed, wherein the stored memory state is generated based on the previous text; and
acquiring a randomly generated memory state in response to not having executed the text generation task for the previous text.

5. The method according to claim 3, further comprising:
processing the memory state and the initial hidden state by using a second attention mechanism to obtain an updated memory state, in response to the generated subsequent text having a text length greater than a predetermined length; and
updating the stored memory state to the updated memory state,
wherein the first attention mechanism is a unidirectional attention mechanism, and the second attention mechanism is a bidirectional attention mechanism.

6. The method according to claim 4, further comprising:
processing the memory state and the initial hidden state by using a second attention mechanism to obtain an updated memory state, in response to the generated subsequent text having a text length greater than a predetermined length; and
updating the stored memory state to the updated memory state,
wherein the first attention mechanism is a unidirectional attention mechanism, and the second attention mechanism is a bidirectional attention mechanism.

7. The method according to claim 5, wherein the memory state comprises a state sequence formed by a plurality of memory sub-states, the updated hidden state is a last hidden state among a plurality of hidden states obtained in sequence, and the processing the memory state and the initial hidden state by using a second attention mechanism to obtain an updated memory state comprises:
processing an i^{th} memory sub-state in the state sequence and an obtained (i−1)^{th} hidden state by using the second attention mechanism to obtain an i^{th} memory sub-state in the updated memory state,
wherein i is a natural number less than or equal to a total number of the plurality of memory sub-states, and a first memory sub-state is obtained by processing the initial hidden state.

8. The method according to claim 6, wherein the updated hidden state is a last hidden state among a plurality of hidden states obtained in sequence, and the processing the memory state and the initial hidden state by using a second attention mechanism to obtain an updated memory state comprises:
processing an i^{th} memory sub-state in the state sequence and an obtained (i−1)^{th} hidden state by using the second attention mechanism to obtain an i^{th} memory sub-state in the updated memory state,
wherein i is a natural number less than or equal to a total number of the plurality of memory sub-states, and a first memory sub-state is obtained by processing the initial hidden state.

9. A method of training a text generation model, comprising:
acquiring a sample text, wherein the sample text comprises a plurality of text segments obtained by dividing a long text;
for each text segment of the plurality of text segments:
acquiring a memory state for the text segment, wherein the memory state is generated based on a previous text of the text segment;
determining an embedding feature of the text segment as an initial hidden state, and processing the memory state and the initial hidden state by using an encoding network in the text generation model to obtain an updated hidden state; and
generating, based on the updated hidden state, a subsequent text for the text segment by using an output layer in the text generation model; and
training the text generation model based on the sample text and subsequent texts for the plurality of text segments,
wherein the encoding network is configured to process the memory state and the initial hidden state by using a first attention mechanism.

10. The method according to claim 9, wherein the memory state comprises a state sequence formed by a plurality of memory sub-states, the encoding network comprises a first encoding sub-network, the first encoding sub-network comprises a plurality of first encoding layers connected in sequence and constructed based on the first attention mechanism, and the processing the memory state and the initial hidden state by using an encoding network in the text generation model to obtain an updated hidden state comprises:
processing, with the embedding feature of the text segment as the initial hidden state, an i^{th} memory sub-state in the state sequence and a current hidden state by using an i^{th} encoding layer among the plurality of first encoding layers to obtain a next hidden state of the current hidden state,
wherein the updated hidden state is the next hidden state obtained by a last encoding layer among the plurality of first encoding layers, and i is a natural number less than or equal to a total number of the plurality of memory sub-states.

11. The method according to claim 9, wherein the acquiring a memory state for the text segment comprises:
acquiring a randomly generated memory state in response to the text segment being a first text segment among the plurality of text segments; and
acquiring a stored memory state in response to the text segment being a text segment among the plurality of text segments other than the first text segment,
wherein the stored memory state is obtained based on a previous text segment of the text segment among the plurality of text segments.

12. The method according to claim 10, wherein the acquiring a memory state for the text segment comprises:
acquiring a randomly generated memory state in response to the text segment being a first text segment among the plurality of text segments; and
acquiring a stored memory state in response to the text segment being a text segment among the plurality of text segments other than the first text segment,
wherein the stored memory state is obtained based on a previous text segment of the text segment among the plurality of text segments.

13. The method according to claim 11, wherein the encoding network further comprises a second encoding sub-network constructed based on a second attention mechanism, and the method further comprises:
processing the memory state and the initial hidden state by using the second encoding sub-network to obtain an updated memory state; and
updating the stored memory state to the updated memory state,
wherein the first attention mechanism is a unidirectional attention mechanism, and the second attention mechanism is a bidirectional attention mechanism.

14. The method according to claim 12, wherein the encoding network further comprises a second encoding sub-network constructed based on a second attention mechanism, and the method further comprises:
processing the memory state and the initial hidden state by using the second encoding sub-network to obtain an updated memory state; and
updating the stored memory state to the updated memory state,
wherein the first attention mechanism is a unidirectional attention mechanism, and the second attention mechanism is a bidirectional attention mechanism.

15. The method according to claim 13, wherein the memory state comprises a state sequence formed by a plurality of memory sub-states, the updated hidden state is a last hidden state among a plurality of hidden states obtained in sequence, the second encoding sub-network comprises a plurality of second encoding layers constructed based on the second attention mechanism, and the processing the memory state and the initial hidden state by using the second encoding sub-network to obtain an updated memory state comprises:
processing an i^{th} memory sub-state in the state sequence and an obtained (i−1)^{th} hidden state by using an i^{th} second encoding layer among the plurality of second encoding layers to obtain an i^{th} memory sub-state in the updated memory state,
wherein i is a natural number less than or equal to a total number of the plurality of memory sub-states, and a hidden state processed by a 1^{st} second encoding layer is the initial hidden state.

16. The method according to claim 9, wherein the training the text generation model based on the sample text and subsequent texts for the plurality of text segments comprises:
back-propagating a gradient of an objective function by using a back-propagation through time algorithm; and
training the text generation model based on a gradient obtained by a back-propagation, with a goal of minimizing the objective function,
wherein the objective function is related to a difference between the subsequent texts for the plurality of text segments and a target text in the sample text, and the target text is a text corresponding to the subsequent text.

17. The method according to claim 16, wherein the back-propagating a gradient of an objective function by using a back-propagation through time algorithm comprises:
determining, in response to the back-propagation proceeding to a target text segment among the plurality of text segments, a text segment sequence formed by two adjacent target text segments that the back-propagation has proceeded to and a text segment between the two adjacent target text segments, wherein the target text segment comprises a last text segment among the plurality of text segments, and a number of target text segments is multiple;
back-propagating the gradient of the objective function within the text segment sequence by using the back-propagation through time algorithm to determine a gradient for a target text segment that the back-propagation currently proceeds to; and
determining the gradient obtained by the back-propagation based on a sum of a plurality of gradients for a plurality of target text segments.

18. The method according to claim 17, further comprising:
determining, in response to the back-propagation proceeding to a target text segment, a memory state acquired for a previous target text segment that the back-propagation has proceeded to of the target text segment that the back-propagation currently proceeds to as a target state;
determining a gradient of the target state; and
determining, based on the gradient of the target state and a change of the target state to the previous target text segment that the back-propagation has proceeded to, an influence degree of a text segment after the previous target text segment that the back-propagation has proceeded to among the plurality of text segments on the gradient for the target text segment that the back-propagation currently proceeds to,
wherein the gradient for the target text segment that the back-propagation currently proceeds to is determined based on a sum of the influence degree and a gradient obtained by back-propagating the gradient of the objective function within the text segment sequence.

19. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
acquire a memory state for a text to be processed, wherein the memory state is generated based on a previous text of the text to be processed;
determine an embedding feature of the text to be processed as an initial hidden state, and process the memory state and the initial hidden state by using a first attention mechanism to obtain an updated hidden state; and
generate a subsequent text for the text to be processed based on the updated hidden state.

20. A non-transitory computer-readable storage medium having computer instructions therein, wherein the computer instructions are configured to cause a computer to implement the method of claim 1.
